(19) United States
(12) Patent Application Publication
(10) Pub. No.: US 2026/0304416 A1
(43) Pub. Date: Oct. 1, 2026

(54) OPTIMIZED ANTENNA TUNING FOR UPLINK TRANSMIT SWITCHING

(71) Applicant: MOTOROLA MOBILITY LLC, WILMINGTON, DE (US)

(72) Inventors: ARMIN W. KLOMSDORF, CHICAGO, IL (US); JOHN VITALE, CHICAGO, IL (US)

(21) Appl. No.: 19/094,962

(22) Filed: Mar. 30, 2025

(51) Int. Cl. H04W 72/1268; H04L 5/14; H04W 72/21; H04W 76/28

(52) U.S. Cl. CPC H04W 72/1268; H04L 5/14; H04W 72/21; H04W 76/28

(57) ABSTRACT

A communication device has an integrated antenna assembly of a collectively smaller footprint by nesting a patch antenna within a coil. The antenna assembly includes a first ferrite layer positioned on and supported by a first ground plane. The coil is positioned over and supported by the first ferrite layer and has a first interior perimeter edge. The patch antenna has a first footprint size that is smaller than, and positioned within, the first interior perimeter edge of the coil. In an example, the patch antenna may be configured to perform functions of one or more of a global positioning system antenna, a satellite communication antenna, and an ultra-wideband (UWB) antenna). The coil may be configured to perform functions of at least one of a near field communication (NFC) antenna and a wireless charging (WLC) coil).

### BACKGROUND

### 1. Technical Field

The present disclosure relates generally to mobile communication devices, and more particularly to mobile communication devices that support uplink carrier switching.

### 2. Description of the Related Art

Portable communication devices, particularly smartphones, have become ubiquitous. Antennas are incorporated into the portable communication devices to support communications in one or more radio frequency (RF) bands using one or more communication protocols. In order to transmit larger volumes of data, the communication device may request use of carrier aggregation to combine uplink resources of more than one uplink carrier. In an example, earlier generation communication protocols included lower frequency bands that inherently could carry a lower amount of data than more recently implemented higher frequency communications bands. Aggregating more than one uplink carrier in these legacy lower bandwidth carriers can achieve the desired data throughput. In addition to carrier aggregation, the communication protocols supported by the portable communication device call for performing multiple input multiple output (MIMO) transmissions, which may utilize frequency division duplex (FDD) and/or time division duplex (TDD). Configuring the multiple antennas of the portable communication device for the various transmissions requires using an antenna tuning code for each active antenna tuner to achieve efficient transmissions.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A presents a functional block diagram of example components of an electronic device in a communication environment and having hardware and software components that enable the features of the present disclosure to be advantageously implemented, according to one or more embodiments;

FIG. 1B is an additional block diagram representation of the electronic device of FIG. 1A presenting additional components, including components for wireless communications with other devices, according to one or more embodiments;

FIG. 2 is a simplified block diagram of a communication environment of the electronic device communicating with a serving network device of a communications network using uplink transmission switching with optimum open-loop antenna tuning, according to one or more embodiments;

FIG. 3A is a slot “0” data structure of an example downlink/uplink carrier aggregation by the electronic device during which antenna tune codes are loaded and uplink transmit switching occurs from frequency division duplex (FDD) to combined FDD and time division duplex (TDD) uplink transmissions, according to one or more embodiments;

FIG. 3B is a slot “1” data structure of the example downlink/uplink carrier aggregation subsequent to slot “0” and during which uplink transmission switches to uplink TDD transmissions, according to one or more embodiments;

FIG. 3C is a slot “2” data structure of the example downlink/uplink carrier aggregation subsequent to slot “1” and during which uplink carriers change, necessitating reloading of antenna codes for subsequent uplink transmission switching from uplink FDD and TDD transmissions to uplink TDD transmissions, according to one or more embodiments;

FIG. 4 is a flow diagram presenting a method for transitioning from closed-loop antenna tuning to open-loop antenna tuning by configuring antenna tuning control with tune codes optimized for uplink transmission switching carrier aggregation combinations among two or more uplink carriers, according to one or more embodiments; and

FIG. 5 is a flow diagram presenting a method for supporting uplink transmit switching according with optimized open loop antenna tuning for carrier aggregation of configured uplink channels, according to one or more embodiments.

### DETAILED DESCRIPTION

According to aspects of the present disclosure, a communication device supports uplink transmit switching according to recently introduced fifth generation (5G) communication protocol with optimized open loop antenna tuning for the configured uplink channels. In an example, the communication supports fifth generation (5G) and subsequent communication protocols that provide uplink carrier aggregation (CA) and uplink multiple input multiple output (MIMO). The communication device supports a dynamic switch between: (i) uplink MIMO, which is high capacity/high data throughput; (ii) a typically lower frequency division duplex (FDD) band coverage; and (iii) a combination of these uplink bands in an uplink CA pairing. Switching transmit paths cannot be done instantaneously, as analog and digital circuits must be put into a ready state or reconfigured. The communication device, often referred to user equipment (UE), reports, to a scheduling network device of a communications network (e.g., a base station), uplink switching time capabilities of the UE for different band combinations. The scheduling network device assigns the radio configuration for the radio resource control (RRC) connection according to the uplink switching time capabilities of the UE. The reporting is performed visa the UCI message which is built statically based on the RF hardware support.

According to one or more embodiments, the communication device has a memory including a communications application and a plurality of transmission tune codes. The communication device has a communications subsystem including a radio frequency (RF) front end having a tuner controller that configures more than one antenna tuner. A controller of the communication device is communicatively coupled to the memory and the communications subsystem. The controller is configured to cause the communication device to transmit, via the communications subsystem to a serving network device, a request for uplink resources to transmit data packets. The controller is configured to cause the electronic device to receive, via the communications subsystem from the serving network device, uplink control information (UCI) scheduling resources for uplink transmit switching in support of a carrier aggregation mode with consecutive uplink slots scheduled across carriers. In response to receiving the UCI, the controller is further configured to cause the communication device to preload the tuner controller with at least three transmission codes of the plurality of tune codes that correspond to RF bands of the uplink transmit switching modes for uplink carrier aggregation configured by the UCI, respectively using time division duplex (TDD), frequency division duplex (FDD), or both TDD and FDD. For each uplink slot, the controller is configured to cause the electronic device to determine, based on the UCI, an uplink transmit switching mode and an associated tune code preloaded in the tune controller that provides a best radiated performance for scheduled resources during the slot. The controller is configured to cause the electronic device to activate the associated tune code using a mobile industry processor interface (MIPI) trigger or dedicated hardware trigger to optimize radiated performance of the communication during uplink transmit switching.

According to one or more embodiments, a method is provided for uplink transmit switching with optimized open loop antenna tuning for the configured uplink channels. The method includes transmitting, to a serving network device, a request for uplink resources to transmit data packets. The method includes receiving, from a serving network device, UCI scheduling resources for uplink transmit switching in support of a carrier aggregation mode with consecutive uplink slots scheduled across carriers. In response to receiving the UCI, the method includes preloading a tuner controller of an RF front end of a communication device with at least three transmission codes of a plurality of tune codes that correspond to RF bands of the uplink transmit switching modes for uplink carrier aggregation configured by the UCI, respectively using TDD, FDD, or both TDD and FDD. For each uplink slot, the method includes determining, based on the UCI, an uplink transmit switching mode and an associated tune code preloaded in the tune controller that provides a best radiated performance for scheduled resources during the slot. The method includes activating the associated tune code using an MIPI trigger or dedicated hardware trigger to optimize radiated performance of the communication during uplink transmit switching.

Further embodiments provide a computer program product that includes: a non-transitory computer readable medium; and program code on the computer readable medium that, when processed by a processor of an electronic system, configures the processor and/or the electronic system to perform functions of the above-described method.

The above contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent within the following detailed description.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized, and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc., do not denote any order or importance, but rather the terms first, second, etc. are used to distinguish one element from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

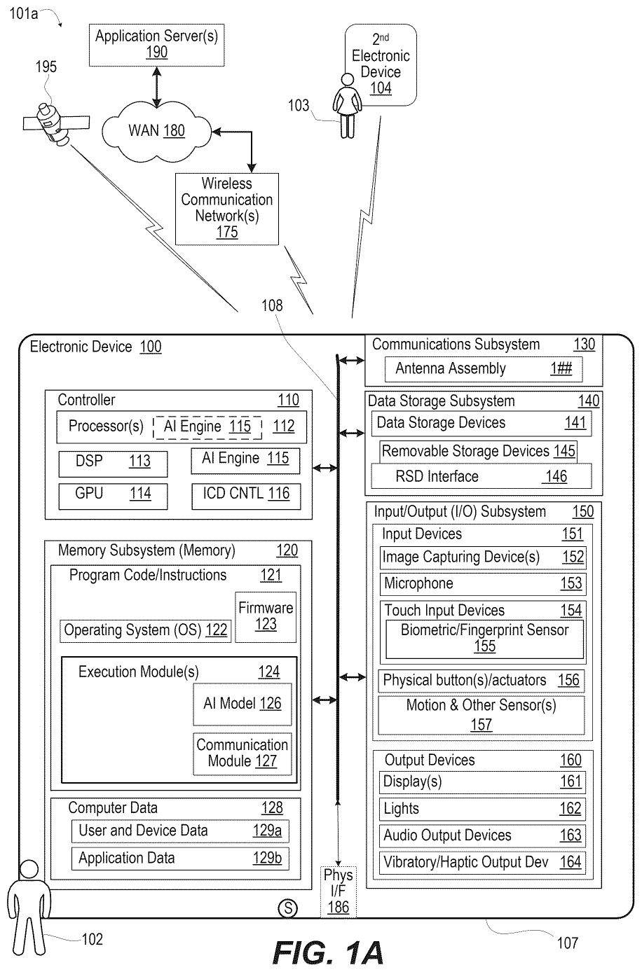

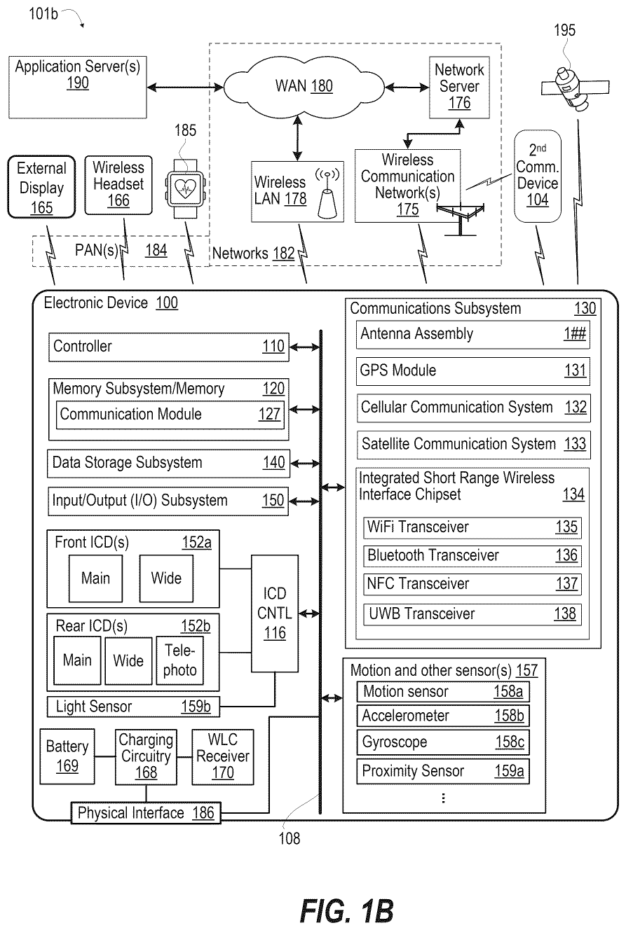

Those of ordinary skill in the art will appreciate that the hardware components and basic configuration depicted in the following figures may vary. For example, the illustrative components within electronic device 100 (FIG. 1A-1B) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural, functional, operational, or otherwise) on the described embodiments.

Referring now to the figures and beginning with FIG. 1A, there is illustrated a block diagram of an example electronic device 100 in communication environment 101a and having hardware and software components, which enable the features of the present disclosure to be advantageously implemented, according to one or more embodiments. Examples of electronic device 100 can include, but are not limited to, mobile devices, a notebook computer, a mobile phone, a smart phone, a digital camera with enhanced processing capabilities, a smart watch, a tablet computer, a heads up display (e.g., smart glasses) worn by user 102, and other types of electronic devices. For purposes of this disclosure, electronic device is assumed to be a communication device that can be used to communicate with second user(s) 103 who use corresponding second electronic device(s) 104. Electronic device 100 can therefore be interchangeably referred to herein as communication device 100.

Electronic device 100 generally includes controller 110, memory (or memory subsystem) 120, communication subsystem 130, data storage subsystem 140, input/output subsystem 150, all contained within or extended from an exterior surface of device housing 107. Controller 110 is shown communicatively connected/coupled via system interlink 108 with each of the subsystems 120, 130, 140, and 150, and is directly or indirectly connected with the individual components within each subsystem 120, 130, 140, and 150. System interlink 108 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components.

Controller 110 includes processor 112, which includes one or more central processing units (CPUs) or data processors. Processor 112 performs many of the features of controller 110 and references to features performed by controller 110 can be interchangeably referred to herein as features of processor 112, and vice-versa. In some embodiments, the various functions associated with controller 110 are integrated into processor 112, and accordingly, references made herein to controller and/or processor are understood to refer to one or both components as providing a single management component within the electronic device 100. For simplicity in describing the features of the electronic device 100, the operational functions provided by one or more of operational components within controller 110, including those provided by processor 112 are collectively described as being performed by controller 110. Collectively, components integrated within controller 110 support computing, classifying, processing, transmitting and receiving of data and information, and presenting of graphical and photographic images within a display.

As illustrated, controller 110 can also include one or more digital signal processors 113, graphics processing units (GPUs) 114, artificial intelligence (AI) engine 115, and image capturing device (ICD) controller 116. In some embodiments, the functionality of each of these additional processing components can be integrated with processor(s) 112. For example, processor 112 can, in some embodiments, include dedicated AI engine 115 and image signal processors (ISPs) (not shown). Processor 112 can further include other processors such as auxiliary processor(s) that may act as a low power consumption, always-on sensor hub for physical sensors.

Controller 110 manages, and in some instances directly controls, the various functions and/or operations of electronic device 100. These functions and/or operations include, but are not limited to including, application data processing, communication, location and navigation tasks, image processing, and signal processing. In one or more alternate embodiments, electronic device 100 may use hardware component equivalents for application data processing and signal processing. For example, electronic device 100 may use special purpose hardware, dedicated processors, general purpose computers, microprocessor-based computers, micro-controllers, optical computers, analog computers, dedicated processors and/or dedicated hard-wired logic. Controller 110 can, in some embodiments, also include a hardware acceleration (HA) unit, which can establish direct memory access (DMA) sessions to route network traffic to various elements within electronic device 100 without direct involvement from processor 112 and/or a device operating system 122.

Memory subsystem (or memory) 120 may include a combination of volatile and non-volatile memory, such as random-access memory (RAM) and read-only memory (ROM). Memory subsystem 120 stores instruction or program code 121 for execution by processor 112 to configure processor 112 (and more generally electronic device 100) to provide the operational functions and features described herein. Instructions/program code 121 (or program code 121 for short) includes instructions for an operating system (OS) 122, firmware 123, such as basic input/output system (BIOS) or Uniform Extensible Firmware Interface (UEFI). Program code 121 includes execution module(s) 124 that collectively provides the various features of the disclosure. Execution module(s) 124 includes, without limitation, communication module 127, which provides the features and operating functionality of the disclosed embodiments when the corresponding program instructions of communication module 127 are processed by/within processor 112/controller 110.

Execution modules 124 further includes AI model(s) 126. In one or more embodiments, processor 112 can utilize AI models 126 to provide AI functionality of processor-integrated AI engines 115. In other embodiments, AI models 126 are directly utilized by AI engine 115. In one or more embodiments, AI model 126 is integrated as a sub-module within communication module 127 and is trained to support the AI features of communication module 127. AI model(s) 126 may include an artificial neural network, a decision tree, a support vector machine, Hidden Markov model, linear regression, logistic regression, Bayesian networks, and so forth. AI model(s) 126 can be individually trained to perform specific tasks and can be arranged in different sets of AI models to generate different types of output. Training of AI model(s) 126 is the process by which AI models are trained to perform specific tasks or achieve certain objectives. The training involves providing the model with a large amount of data and allowing the model to learn from patterns and relationships within that data.

Each of the above-introduced module(s) and/or application(s) provides program instructions/code that are processed by processor 112 and which configures processor 112 (and/or controller 110) and/or other operational components of electronic device 100 to cause the electronic device 100 to perform specific operations and functions, as described herein. Descriptive names assigned to these modules add no functionality and are provided solely to assist in identifying the underlying features performed by processing the different modules.

Program code 121 can further include instructions/code for other applications (not shown) providing different features of/within electronic device 100. In one or more embodiments, program code 121 may be integrated into a distinct chipset or hardware module as firmware that operates separately from other executable program code. Portions of program code 121 may be incorporated into different hardware components that operate in a distributed or collaborative manner.

Memory subsystem 120 also includes computer data 128. During execution of program code 121, processor 112 may access, use, generate, modify, store, or communicate computer data 128, such as user and device data 129a and application data 129b. Computer data 128 may incorporate “data” that originated as raw, real-world “analog” information that consists of basic facts and figures. Computer data 128 includes different forms of data, such as numerical data, images, coding, notes, and financial data, as well as data presenting video, graphics, text, and images. Computer data 128 may originate at electronic device 100 or may be retrieved from a remote device via communications subsystem 130. Electronic device 100 may store, modify, present, or transmit computer data 128.

Communications subsystem 130 includes various components that enable electronic device 100 to communicate with external communication networks and other devices, such as second electronic device 104 and application server(s) 190, etc., via communications subsystem 130. According to one or more embodiments, communication module 127 presented within program code 121 includes instructions supporting the use of communications subsystem 130 to establish communication interfaces enabling communication by electronic device 100 with these external networks and devices.

Data storage subsystem 140 of electronic device 100 includes data storage device(s) 141. Controller 110 is communicatively connected, via system interlink 108, to data storage device(s) 141. Data storage subsystem 140 provides stored versions of program code 121 and computer data 128 on nonvolatile storage that is accessible by controller 110. The program code 121 can be loaded into memory 120 for execution/processing by controller 110. In one or more embodiments, data storage device(s) 141 can include hard disk drives (HDDs), optical disk drives, and/or solid-state drives (SSDs), etc.

Data storage subsystem 140 of electronic device 100 can include removable storage device(s) (RSD(s)) 145, which is received in RSD interface 146. Controller 110 is communicatively connected to RSD 145, via system interlink 108 through RSD interface 146. In one or more embodiments, RSD 145 is a non-transitory computer program product or computer readable storage device that stores program code and associated data, including a copy of AI model(s) 126 and communication module 127, which may be executed by a processor associated with a user device, such as electronic device 100. Controller 110 can access data storage device(s) 141 or RSD(s) 145 to provision electronic device 100 with stored program code 121 and computer data 128 that, when executed/processed by processor 112, the program code configures processor 112 and/or more generally electronic device 100, to provide the various functions described herein.

I/O subsystem 150 includes input devices 151 such as, but not limited to, image capturing device(s) (ICDs) 152, microphone 153, and touch input devices 154 (e.g., touch screens, keys, or buttons) for use by user 102 to interface with electronic device 100. Touch input devices 154 can include a biometric/fingerprint sensor 155 for biometric input. Biometric/fingerprint sensor 155 can be used to read/receive biometric data, such as fingerprints, to identify or authenticate a user. In some embodiments, the biometric sensor 155 can supplement an ICD (camera), which captures images for user detection/identification via facial recognition.

Input devices 151 may include physical buttons/actuators 156 that can be located on a periphery of the device housing 107. Physical buttons/actuators 156 may provide controls for volume, power, and ICDs 152. Microphone 153 can also be referred to as an audio input device. In some embodiments, microphone 153 may be used for identifying a user via voiceprint, voice recognition, and/or other suitable techniques. Input devices 151 can also include one or more motion or other sensor(s) 157, which are further defined in the FIG. 1B description which.

With reference to FIG. 1B, as illustrated, motion and other sensor(s) 157 of electronic device 100 include, but are not limited to, one or more motion sensor(s) 158a, one or more accelerometers 158b, one or more gyroscopes 158c, and proximity sensor 159a, etc. Motion sensor(s) 158a detects movement of electronic device 100 and provides motion data to processor 112 indicating the spatial orientation, position and movement of electronic device 100. Accelerometers 158b measure linear acceleration of movement of electronic device 100 in multiple axes (X, Y and Z). For example, accelerometers 158b can include three accelerometers, where one accelerometer measures linear acceleration in the X axis, one accelerometer measures linear acceleration in the Y axis, and one accelerometer measures linear acceleration in the Z axis. Accelerometers 158b can be used to calculate the orientation/position of electronic device 100 relative to the earth and can also be referred to as a gravity sensor. Gyroscope 158c measures rotation or angular rotational velocity of electronic device 100. Proximity sensor 159a senses the presence of nearby objects. In one embodiment, proximity sensor 159a can be an infrared (IR) sensor that detects the presence of a nearby object, such as when electronic device 100 is in a pocket of a user. Electronic device 100 can also include one or more light sensors 159b, which detects the luminance and/or intensity (i.e., the amount) of ambient light surrounding the electronic device 100.

Referring again to FIG. 1A, I/O subsystem 150 includes output devices 160 such as, but not limited to, display(s) 161, lights 162, audio output devices 163, and vibratory and/or haptic output devices 164. In one or more embodiments, electronic device 100 includes an integrated display 161 which incorporates a tactile, touch screen interface that can receive user's tactile/touch input. As a touch screen device, integrated display 161 allows a user to provide input to and/or to control electronic device 100 by touching features within a user interface presented on integrated display 161. Tactile touch screen interface (154) can be utilized as an input device. The touch screen interface (154) can include one or more virtual buttons or selectable affordances. In one or more embodiments, when a user applies a finger or stylus on the touch screen interface (154) in the region demarked by the virtual button, the touch of the region causes the processor 112 to execute code to implement a function associated with the virtual button. In some implementations, integrated display 161 is integrated into a front surface of electronic device housing 107 along with front image capturing devices (not specifically shown), while the higher quality ICDs are located on a rear surface of device housing 107. Other embodiments provide multiple integrated displays within electronic device 100 and references to display(s) 161 are assumed to refer to one or all of these multiple integrated displays.

Vibration/haptic output device 164 can cause electronic device 100 to vibrate or shake when activated. Vibration/haptic output device 164 can be activated during an incoming call or message in order to provide an alert or notification to a user of electronic device 100. In one or more embodiments, integrated display 161, audio output devices (or speakers) 163, and vibration/haptic device 164 can generally and collectively be referred to as output devices.

With reference again to FIG. 1B and with continuing reference to FIG. 1A, there is presented another view of electronic device 100 with components enabling electronic device 100 to function as a mobile communication device, within an expanded communication environment 101b. In addition to the functional and operational components already presented by and described within the description of FIG. 1A, FIG. 1B further illustrates expanded communications subsystem 130 with additional communication components and interfaces enabling electronic device 100 to perform wireless communications within an expanded communication environment 101b that includes other devices.

Communications subsystem 130 includes global positioning system (GPS) module 131 that enables electronic device to communicate with and receive GPS location data from GPS satellite(s) 195. In one or more embodiments, GPS module 131 receives geospatial input from GPS broadcasts of time data and location data from GPS satellite(s) 195 to obtain geospatial location information about the physical location of electronic device 100.

In one or more embodiments, controller 110, via communications subsystem 130, performs multiple types of cellular over-the-air (OTA) or non-cellular wireless communication, such as by using a Bluetooth connection or other personal access network (PAN) connection. As shown, communications subsystem includes cellular communication system 132, which includes at least one radio frequency RF front end coupled to one or more antennas. In one or more embodiments, cellular communication system 132 can include a communication module with one or more baseband processors or digital signal processors, one or more modems, and a radio frequency (RF) front end having one or more transmitters and one or more receivers. In one or more embodiments, controller 110, via communications subsystem 130, may communicate via an OTA cellular connection with radio access networks (RANs) over a cellular wireless communication network (CWCN) 175. CWCN 175 can be a terrestrial network and include a plurality of base stations and associated network server(s) 176, in one embodiment. Cellular communication system 132 allows electronic device 100 to communicate wirelessly with CWCN 175 via transmissions of communication signals (represented as lightning bolts) to and from network communication devices, such as base stations or cellular nodes, of CWCN 175. Alternatively, or in addition, CWCN 175 can include a satellite network, and electronic device 100 connects to CWCN 175 using satellite communication system 133. Cellular communication system 132 and satellite communication system 133 enable electronic device 100 to engage in long distance wireless communication capabilities.

In one or more embodiments, communications subsystem 130 includes integrated short range wireless interface chipset 134 having one or more of Wi-Fi transceiver (TxRX) 135, Bluetooth (BT) TxRx 136, near field communication (NFC) transceiver 137, and ultra-wideband (UWB) transceiver 138. In one or more embodiments, the short-range communication devices are not integrated on a single chipset but can be separately provided hardware components. In one or more embodiments, electronic device 100 can communicate wirelessly with external wireless devices, such as a Wi-Fi router of a wireless local area network (WLAN) 178 and/or second electronic device 104, via one or more short-range wireless interface(s). Second electronic device 104 can be a communication device, such as a smartphone, and/or can be similarly configured as electronic device 100. Second user 103 may operate second electronic device 104. In one or more embodiments, electronic device 100 can receive Internet or Wi-Fi based calls, text messages, multimedia messages, and other notifications via a combination of wireless and wired networks (generally networks 182).

In one or more embodiments, networks 182 can include CWCN 175, WLAN 178, and Wide Area Network (WAN) 180, such as the Internet. In one or more embodiments, WAN 180 can enable electronic device 100 to access application servers 190, which can provide a downloadable version of communication module 127 and/or access to other applications, online transactions, and resources.

In one or more embodiments, networks 182 can also include personal area networks (PAN) 184, which are individually created with second devices via one of short-range wireless devices from among Wi-Fi TxRX 135, BT TxRx 136, NFC transceiver 137, and UWB transceiver 138. Example second devices include external display 165, wireless headset 166, and wearable computing device 185. External display 165 can be a stand-alone monitor/display or a display integrated into a second electronic device, such as a laptop computer. In at least one embodiment, connection to the external display 165 can be wired and can include an intermediate connection device, such as a docking station device. In one or more embodiments, wearable computing device 185, such as a smartwatch, fitness tracker, or the like, may be paired with electronic device 100, and provide biometric data such as heart rate, breathing rate, and the like, to the electronic device 100 via the paired communication link.

Electronic device 100 also includes a physical interface 186. Physical interface 186 of electronic device 100 can serve as an input/output data port and can be used as a power supply port that is coupled to charging circuitry 168 which feeds electrical power to device battery 169 to enable recharging of device battery 169 and/or powering of electronic device 100. Alternatively, or in addition, Wireless charging (WLC) receiver 170 may include one or more magnetic loop antennas in which a current is induced by receiving an oscillating magnetic field. WLC receiver 170 provides the current to charging circuit 168. As a data port, physical interface 186 can enable electronic device 100 to be physically coupled via a cable or docking station port to a second device, such as external display 165.

FIG. 1B also presents additional details of ICD(s) 152 of electronic device 100. Throughout the disclosure, the term image capturing device (ICD) is synonymous with and/or utilized interchangeably with any one of the cameras of electronic device 100. ICD(s) (or cameras) 152 includes front cameras 152a and rear cameras 152b. In one embodiment, each of front cameras 152a and rear cameras 152b are communicatively coupled to ICD controller 116. ICD controller 116 supports the processing of image data from front cameras 152a and rear cameras 152b. Front cameras 152a can include a main camera and a wide-angle camera. Rear ICDs cameras 152b can include a main camera, a wide-angle camera, and a telephoto camera. Both sets of cameras 152 include image sensors that can capture images that are within the field of view (FOV) of each respective camera 152. In one or more embodiments, one or more of the cameras can be utilized to enable biometric authentication using facial image and/or iris scan recognition.

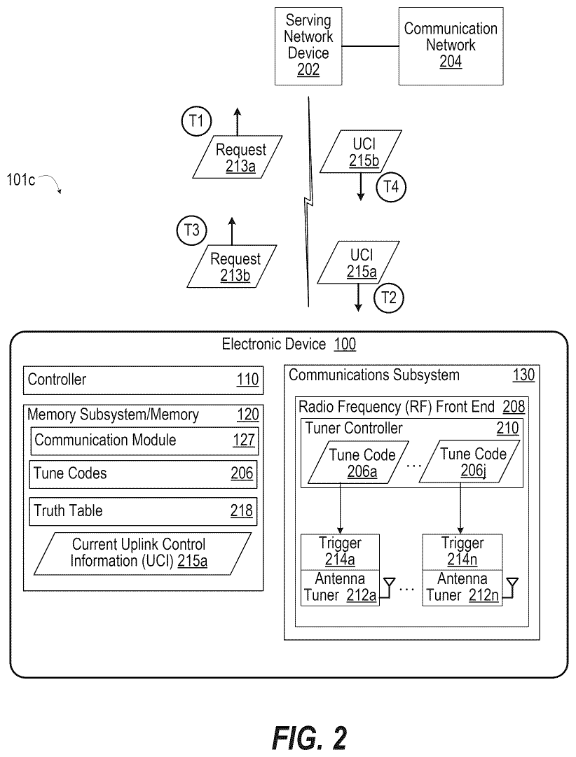

FIG. 2 is a simplified block diagram of a communication environment 101c of electronic device 100 communicating with serving network device 202 of communications network 204 using uplink transmission switching with optimum open-loop antenna tuning. Serving network device 202 and communication network 204 may include one or components and systems described above with regard to FIG. 1A-1B. In an example implementation, electronic device 100 is a communication device having memory 120 including communications module 127 and a plurality of transmission tune codes 206. In an example, tune codes 206 include at least three tune codes, represented as tune codes 206a-206j (collectively “206”) to cover combinations of one or more of two uplink carriers. In another example, tune codes 206 covers combinations of one or more of at least three uplink carriers. Electronic device 100 has communications subsystem 130 including radio frequency (RF) front end 208 having tuner controller 210 that configures more than one antenna tuner 212a-212n. Controller 110 is communicatively coupled to memory 120 and communications subsystem 130. At first time “T1”, controller 110 is configured to cause electronic device 100 to transmit, via communications subsystem 130 to serving network device 202, request 213a for uplink resources to transmit data packets. At second time “T2”, electronic device 100 receives, via communications subsystem 130 from serving network device 202, uplink control information (UCI) 215a scheduling resources for uplink transmit switching in support of a carrier aggregation mode with consecutive uplink slots scheduled across carriers. Controller 210 stores UCI 215a in memory 120. In response to receiving the UCI scheduling resources, controller 110 is configured to cause electronic device 100 to preload tuner controller 210 with at least three transmission codes of the plurality of tune codes tune codes 206a-206j that correspond to RF bands of the uplink transmit switching modes for uplink carrier aggregation configured by the UCI. In an example, the uplink carrier aggregation uses one of: (i) time division duplex (TDD); (ii) frequency division duplex (FDD); or (iii) both TDD and FDD. For each uplink slot, controller 110 is configured to cause electronic device 100 to determine, based on the UCI, an uplink transmit switching mode and an associated tune code 206 preloaded in tune controller 210 that provides a best radiated performance for scheduled resources during the slot. Controller 110 is configured to cause electronic device 100 to activate the associated tune code using triggers 214a-214n such as a mobile industry processor interface (MIPI) trigger or a dedicated hardware trigger to optimize radiated performance of the communication during uplink transmit switching.

In one or more embodiments, controller 110 is configured to cause electronic device 100 to perform, by RF front end 208, closed loop antenna tuning of the more than one antenna tuner 212a-212n prior to being configured for the uplink transmit switching. In response to UCI scheduling the uplink transmit switching, controller 110 is configured to cause electronic device 100 to configure the tuner controller to discontinue closed loop tuning in preparation for open loop tuning for uplink transmit switching in support of carrier aggregation transmission.

In one or more embodiments, at a third time “T3” controller 110 is configured to cause electronic device 100 to transmit, via communications subsystem 130 to the serving network device, subsequent request 213b for subsequent uplink resources to transmit subsequent data packets. At a fourth time “T4”, controller 110 is configured to cause electronic device 100 to receive, via communications subsystem 130 from serving network device 202, subsequent UCI 215b that indicates a change in an uplink carrier aggregation configuration from the previously received UCI. In response to receiving the change in uplink carrier aggregation, controller 110 is configured to cause electronic device 100 to preload tuner controller 210 with at least three transmission codes of the plurality of tune codes 206a-206j that correspond to RF bands of subsequent uplink transmit switching modes for uplink carrier aggregation configured by the subsequent UCI. For each uplink slot, controller 110 is configured to cause electronic device 100 to determine, based on the subsequent UCI, an uplink transmit switching mode and an associated tune code 206 preloaded in tune controller 210 that provides a best radiated performance for RF bands of scheduled resources during the slot. Controller 110 is configured to cause electronic device 100 to activate associated tune code 206 using corresponding trigger 214a-214n such as a mobile industry processor interface (MIPI) trigger or dedicated hardware trigger to optimize radiated performance of the communication during uplink transmit switching.

In one or more particular embodiments, the change in the uplink carrier aggregation configuration is from among a group including: (i) a first mode change between FDD uplink SISO and TDD uplink MIMO; (ii) a second mode change between FDD uplink MIMO and TDD uplink SISO; (iii) a third mode change between FDD uplink MIMO and TDD uplink MIMO; and (iv) a fourth mode change between a first TDD band uplink MIMO and a second TDD band uplink MIMO using different RF bands than the first TDD band uplink MIMO.

In one or more particular embodiments, the at least three transmission tune codes 206a 206j include: (i) a first uplink carrier tune code; (ii) a second uplink carrier tune code; and (iii) a combined first and second uplink carriers tune code. In one or more embodiments, at least three transmission tune codes 206a-206j include tune codes optimized for unique combinations of one or more of at least three or more uplink carriers.

In one or more embodiments, memory 120 includes truth table 218 that cross references each unique combination of one or more uplink carrier to a corresponding transmission tune code 206 that is optimized for the unique combination. Controller 110 is further configured to cause electronic device 100 to select the corresponding transmission tune code 206 based on truth table 218. A tune code is mapped to each combination of uplink carriers as being the optimum tune code for transceiving efficiency. In one or more embodiments, truth table 218 cross references each unique combination of an RF band type and the one of MIMO and SISO to a corresponding transmission tune code 206 that is optimized for the unique combination.

In one or more embodiments, controller 110 is configured to cause electronic device 100 to transmit, via communications subsystem 130 to serving network device 202, a subsequent request for uplink resources to transmit data packets. Controller 110 is configured to cause electronic device 100 to receive, via communications subsystem 130 from serving network device 202, subsequent uplink control information (UCI) scheduling resources. In response to receiving the subsequent UCI scheduling resources, controller 110 is configured to cause electronic device 100 to reconfigure the communication device to discontinue uplink transmit switching in a carrier aggregation mode. Controller 110 is configured to cause electronic device 100 to discontinue open loop tuning. Controller 110 is configured to cause electronic device 100 to reconfigure tuner controller 210 for closed loop antenna tuning.

In one or more embodiments, the at least three transmission tune codes 206a-206j include: (i) a TDD uplink/downlink multiple-input multiple-output (MIMO) tune code; (ii) an FDD single-input single-output (SISO) tune code; and (iii) an uplink TDD-FDD tune code. In one or more embodiments, the at least three transmission tune codes 206a-206j include a unique combination of an RF band type and one of multiple-input multiple-output (MIMO) transmission and single-input single-output (SISO) transmission.

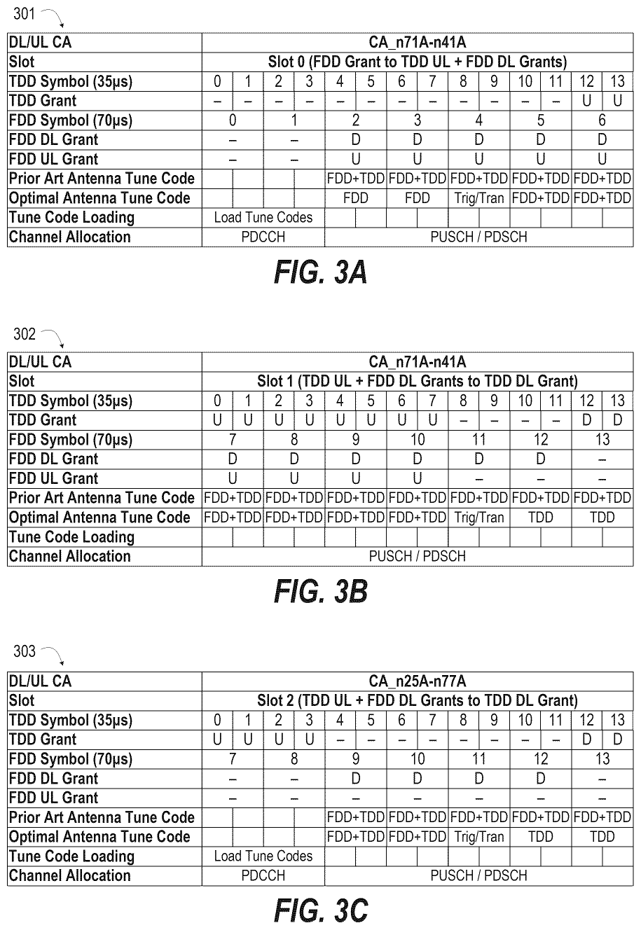

In one or more particular embodiments, FIG. 3A-3C depict example data structures 301-303 respectively for antenna tuning for an uplink transmission switching period of 140 μsec. The switching period corresponds to an amount of time electronic device 100 (FIG. 1A) needs to switch between FDD uplink transmission and TDD uplink transmission. FIG. 3A presents slot “0” data structure 301 of an example downlink/uplink carrier aggregation by electronic device 100 during which antenna tune codes 206 (FIG. 2) are loaded as indicated in row “tune code loading” and uplink transmit switching occurs from frequency division duplex (FDD) to combined FDD and time division duplex (TDD) uplink transmissions as indicated in “optimal antenna tune code” row. In a conventional approach to transmit switching in row “prior art antenna tune code”, a transmit code corresponding to FDD+TDD would be used as a compromise even if only one of FDD or TDD is being used for which a respective optimum tune code exists that would provide better antenna tuning than the compromise FDD+TDD tune code.

FIG. 3B present slot “1” data structure 302 of the example downlink/uplink carrier aggregation subsequent to slot “0” and during which uplink transmission switches to uplink TDD transmissions. Tune controller 210 (FIG. 2) is preloaded as performed in FIG. 3A with at least three tune codes and expeditiously switch to different uplink carrier(s), such as switching from FDD+TDD to TDD as depicted in “optimal antenna tune code” row.

FIG. 3C presents slot “2” data structure 303 of the example downlink/uplink carrier aggregation subsequent to slot “1” and during which uplink carriers change, necessitating reloading of antenna codes as indicated in “tune code loading” row for subsequent uplink transmission switching from uplink FDD and TDD transmissions to uplink TDD transmissions as indicated in “optimal antenna tune code” row. Slot 2 data structure 303 is an example of transmit switching between two different open loop tuning schemes based on a change in one or more uplink carriers.

With returning reference to FIG. 2, when electronic device 100 is in closed loop tuning (e.g., tuning period of 200 msec), electronic device 100 may enter into uplink transmit switching. In response, electronic device 100 discontinues closed loop tuning. Conversely, when electronic device 100 discontinues open loop uplink transmit switching, electronic device 100 resumes closed loop tuning. When electronic device 100 is configured for a different uplink transmit switching uplink combination, electronic device 100 preloads antenna tune control 210 for newly scheduled uplink transmit switching uplink carrier combination.

When electronic device 100 enters uplink transmit switching, if the antenna tuning mode is configured for closed loop tuning, e.g., with a tuning period of 200 msec, electronic device 100 discontinues closed loop tuning. Conversely, when electronic device 100 exits uplink transmit switching, electronic device 100 resumes closed loop antenna tuning. Depending on whether electronic device 100 is downlink or uplink limited, preloading antenna tune codes provides a best overall uplink transmit switching radiated performance.

In a current example, uplink transmit switching is made between TDD UL MIMO and FDD UL SISO transmissions. However, uplink transmit switching is applicable to all combinations of band type and SISO/MIMO. For example, all of these transmit switching cases are covered by the present disclosure: (i) between FDD UL SISO and TDD UL MIMO; (ii) between FDD UL MIMO and TDD UL SISO; (iii) between FDD UL MIMO and TDD UL MIMO; and (iv) between TDD UL MIMO and TDD UL MIMO. In addition, uplink transmit switching can be between two different TDD band as well and is not limited FDD and TDD pairs. Uplink transmit switching supports advanced uplink figures for higher uplink throughput and lower latency. The switching between TDD uplink MIMO and FDD uplink SISO transmissions may be required to occur in as little as 35 μsec or more commonly 140 μsec. The present disclosure provides optimal antenna tuning as compared to the conventional use of one tune code FDD+TDD that is suboptimal by 2-3 dB.

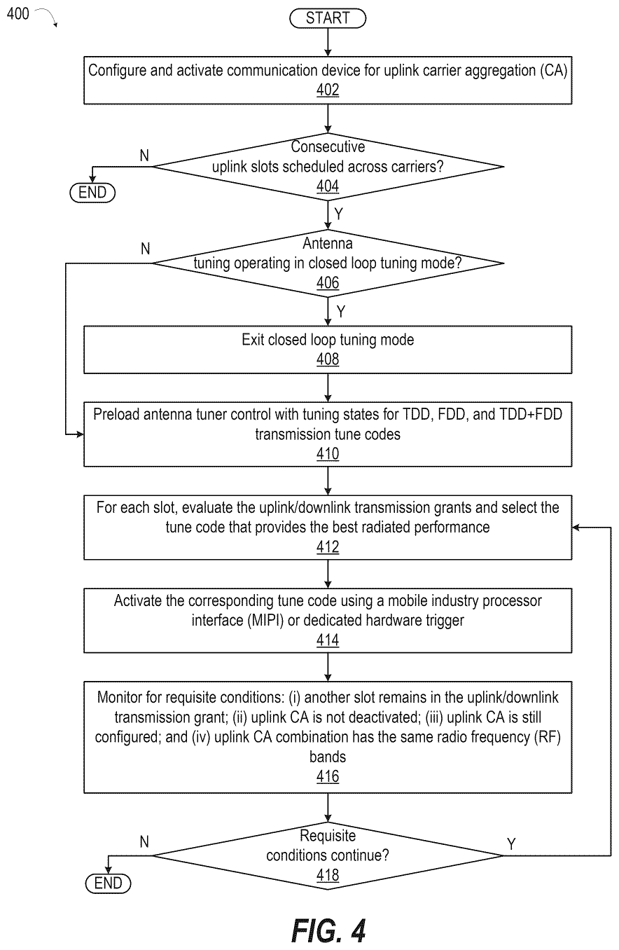

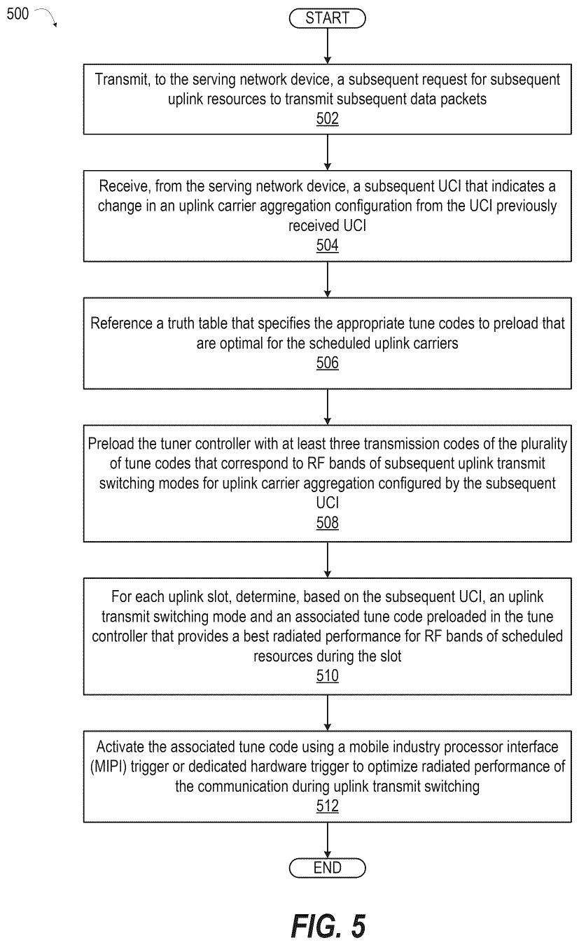

FIG. 4 is a flow diagram presenting a method for transitioning from closed-loop antenna tuning to open-loop antenna tuning by configuring antenna tuning control with tune codes optimized for uplink transmission switching carrier aggregation combinations among two or more uplink carriers. FIG. 5 is a flow diagram presenting a method for supporting uplink transmit switching according to optimized open loop antenna tuning for carrier aggregation of configured uplink channels. The descriptions of method 400 (FIG. 5) and method 500 (FIG. 5) are provided with general reference to the specific components illustrated within the preceding FIG. 1A-1B and 2-3. Specific components referenced in method 400 (FIG. 4) and method 500 (FIG. 5) may be identical or similar to components of the same name used in describing preceding FIG. 1A 1B and 2-3. In one or more embodiments, controller 110 (FIG. 1A) is configured to cause electronic device 100 (FIG. 1A-1B) or a similar computing device to provide the described functionality of method 400 (FIG. 4) and method 500 (FIG. 5).

With reference to FIG. 4, method 400 includes configuring and activating communication device for uplink carrier aggregation (CA) (block 402). Method 400 includes determining whether consecutive uplink slots are scheduled across carriers (decision block 404). In response to determining that consecutive uplink slots are not scheduled across carriers, method 400 ends. In response to determining that consecutive uplink slots are scheduled across carriers, method 400 includes determining whether antenna tuning is operating in closed loop tuning mode (decision block 406). In response to determining that antenna tuning is operating in closed loop tuning mode, method 400 includes exiting closed loop tuning mode (block 408). In response to determining that antenna tuning is not operating in closed loop tuning mode (i.e., is in open loop tuning mode) in decision block 406 or after exiting closed loop tuning mode in block 408, method 400 includes preloading antenna tuner control with tuning states for TDD, FDD, and TDD+FDD transmission tune codes (block 410). For each slot, method 400 includes evaluating the uplink/downlink transmission grants and selecting the tune code that provides the best radiated performance (block 412). Method 400 includes activating the corresponding tune code using a mobile industry processor interface (MIPI) or dedicated hardware trigger (block 414). Method 400 includes monitoring for requisite conditions: (i) another slot remains in the uplink/downlink transmission grant; (ii) uplink CA is not deactivated; (iii) uplink CA is still configured; and (iv) uplink CA combination has the same radio frequency (RF) bands (block 416). Method 400 includes determining whether the requisite conditions continue (decision block 418). In response to determining that the requisite conditions for uplink carrier aggregation do not continue, method 400 ends. In response to determining that the requisite conditions continue, method 400 returns to block 412 for the next slot.

With reference to FIG. 5, method 500 includes transmitting, to the serving network device, a subsequent request for subsequent uplink resources to transmit subsequent data packets (block 502). Method 500 includes receiving, from the serving network device, a subsequent UCI that indicates a change in an uplink carrier aggregation configuration from the previously received UCI (block 504). In one or more embodiments, method 500 may include referencing a truth table that specifies the appropriate tune codes to preload that are optimal for the scheduled uplink carriers (block 506). Method 500 includes preloading the tuner controller with at least three transmission codes of the plurality of tune codes that correspond to RF bands of subsequent uplink transmit switching modes for uplink carrier aggregation configured by the subsequent UCI (block 508). For each uplink slot, method 500 includes determining, based on the subsequent UCI, an uplink transmit switching mode and an associated tune code preloaded in the tune controller that provides a best radiated performance for RF bands of scheduled resources during the slot (block 510). Method 500 includes activating the associated tune code using a mobile industry processor interface (MIPI) trigger or dedicated hardware trigger to optimize radiated performance of the communication during uplink transmit switching (block 512). Then method 500 ends.

According to aspects of the present disclosure, method 500 includes transmitting, to a serving network device, a request for uplink resources to transmit data packets. Method 500 includes receiving, from a serving network device, UCI scheduling resources for uplink transmit switching in support of a carrier aggregation mode with consecutive uplink slots scheduled across carriers. Method 500 includes preloading a tuner controller of a radio frequency (RF) front end of a communication device with at least three transmission codes of a plurality of tune codes that correspond to RF bands of the uplink transmit switching modes for uplink carrier aggregation configured by the UCI, respectively using time division duplex (TDD), frequency division duplex (FDD), or both TDD and FDD. For each uplink slot, method 500 includes determining, based on the UCI, an uplink transmit switching mode and an associated tune code preloaded in the tune controller that provides a best radiated performance for scheduled resources during the slot. Method 500 includes activating the associated tune code using a mobile industry processor interface (MIPI) trigger or dedicated hardware trigger to optimize radiated performance of the communication during uplink transmit switching.

According to aspects of the present disclosure, the electronic device 100 (FIG. 1A), method 400 (FIG. 4), method 500 (FIG. 5), and computer program product, such as RSD 145 (FIG. 1A), provide techniques for uplink transmit switching that provides optimal antenna switching as compared to the conventional use of one tune code FDD+TDD that is suboptimal by 2-3 dB. Preloading three or more tune codes support the short switching times of 35 μsec or more, accommodating for the hardware limitations of tuner controls and antenna tuners.

Aspects of the present innovation are described above with reference to flowchart illustrations and/or block diagrams of methods, apparatus (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a “circuit,” “module” or “system.”

While the innovation has been described with reference to exemplary embodiments, it will be understood by those skilled in the art that various changes may be made, and equivalents may be substituted for elements thereof without departing from the scope of the innovation. In addition, many modifications may be made to adapt a particular system, device, or component thereof to the teachings of the innovation without departing from the essential scope thereof. Therefore, it is intended that the innovation not be limited to the particular embodiments disclosed for carrying out this innovation, but that the innovation will include all embodiments falling within the scope of the appended claims. Moreover, the use of the terms first, second, etc., do not denote any order or importance, but rather the terms first, second, etc. are used to distinguish one element from another.

The terminology used herein is for the purpose of describing particular embodiments only and is not intended to be limiting of the innovation. As used herein, the singular forms “a”, “an” and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present innovation has been presented for purposes of illustration and description but is not intended to be exhaustive or limited to the innovation in the form disclosed. Many modifications and variations will be apparent to those of ordinary skill in the art without departing from the scope and spirit of the innovation. The embodiments were chosen and described in order to best explain the principles of the innovation and the practical application, and to enable others of ordinary skill in the art to understand the innovation for various embodiments with various modifications as are suited to the particular use contemplated.

What is claimed is:

1. A communication device comprising:
a memory comprising a communications application and a plurality of transmission tune codes;
a communications subsystem comprising a radio frequency (RF) front end having a tuner controller that configures more than one antenna tuner; and
a controller communicatively coupled to the memory and the communications subsystem and configured to cause the communication device to:
transmit, via the communications subsystem to a serving network device, a request for uplink resources to transmit data packets; and
in response to receiving, via the communications subsystem from the serving network device, uplink control information (UCI) scheduling resources for uplink transmit switching in support of a carrier aggregation mode with consecutive uplink slots scheduled across carriers:
preload the tuner controller with at least three transmission codes of the plurality of tune codes that correspond to RF bands of the uplink transmit switching modes for uplink carrier aggregation configured by the UCI, respectively using time division duplex (TDD), frequency division duplex (FDD), or both TDD and FDD;
for each uplink slot, determine, based on the UCI, an uplink transmit switching mode and an associated tune code preloaded in the tune controller that provides a best radiated performance for scheduled resources during the slot; and
activate the associated tune code using a mobile industry processor interface (MIPI) trigger or dedicated hardware trigger to optimize radiated performance of the communication during uplink transmit switching.

2. The communication device of claim 1, wherein the controller is further configured to cause the communication device to:
perform, by the RF front end, closed loop antenna tuning of the more than one antenna tuner, previously to being configured for the uplink transmit switching; and
in response to UCI scheduling the uplink transmit switching, configure the tuner controller to discontinue closed loop tuning in preparation for open loop tuning for uplink transmit switching in support of carrier aggregation transmission.

3. The communication device of claim 1, wherein the controller is further configured to cause the communication device to:
transmit, via the communications subsystem to the serving network device, a subsequent request for subsequent uplink resources to transmit subsequent data packets; and
in response to receiving, via the communications subsystem from the serving network device, a subsequent UCI that indicates a change in an uplink carrier aggregation configuration from the UCI previously received:
preload the tuner controller with at least three transmission codes of the plurality of tune codes that correspond to RF bands of subsequent uplink transmit switching modes for uplink carrier aggregation configured by the subsequent UCI;
for each uplink slot, determine, based on the subsequent UCI, an uplink transmit switching mode and an associated tune code preloaded in the tune controller that provides a best radiated performance for RF bands of scheduled resources during the slot; and
activate the associated tune code using a mobile industry processor interface (MIPI) trigger or dedicated hardware trigger to optimize radiated performance of the communication during uplink transmit switching.

4. The communication device of claim 3, wherein the change in the uplink carrier aggregation configuration is from among a group comprising: (i) a first mode change between FDD uplink SISO and TDD uplink MIMO; (ii) a second mode change between FDD uplink MIMO and TDD uplink SISO; (iii) a third mode change between FDD uplink MIMO and TDD uplink MIMO; and (iv) a fourth mode change between a first TDD band uplink MIMO and a second TDD band uplink MIMO using different RF bands than the first TDD band uplink MIMO.

5. The communication device of claim 1, wherein the at least three transmission tune codes comprise: (i) a first uplink carrier tune code; (ii) a second uplink carrier tune code; and (iii) a combined first and second uplink carriers tune code.

6. The communication device of claim 1, wherein:
the memory comprises a truth table that cross references each unique combination of one or more uplink carrier to a corresponding transmission tune code that is optimized for the unique combination; and
the controller is further configured to cause the communication device to select the corresponding transmission tune code based on the truth table.

7. The communication device of claim 1, wherein the at least three transmission tune codes comprise tune codes optimized for unique combinations of one or more of at least three uplink carriers.

8. The communication device of claim 1, wherein the controller is further configured to cause the communication device to:
transmit, via the communications subsystem to a serving network device, a subsequent request for subsequent uplink resources to transmit subsequent data packets; and
in response to receiving, via the communications subsystem from the serving network device, subsequent uplink control information (UCI) scheduling resources:
reconfigure the communication device to discontinue uplink transmit switching in a carrier aggregation mode;
discontinue open loop tuning; and
reconfigure the tuner controller for closed loop antenna tuning.

9. A method comprising:
transmitting, to a serving network device, a request for uplink resources to transmit data packets; and
in response to receiving, a serving network device, uplink control information (UCI) scheduling resources for uplink transmit switching in support of a carrier aggregation mode with consecutive uplink slots scheduled across carriers:
preloading a tuner controller of a radio frequency (RF) front end of a communication device with at least three transmission codes of a plurality of tune codes that correspond to RF bands of the uplink transmit switching modes for uplink carrier aggregation configured by the UCI, respectively using time division duplex (TDD), frequency division duplex (FDD), or both TDD and FDD;
for each uplink slot, determining, based on the UCI, an uplink transmit switching mode and an associated tune code preloaded in the tune controller that provides a best radiated performance for scheduled resources during the slot; and
activating the associated tune code using a mobile industry processor interface (MIPI) trigger or dedicated hardware trigger to optimize radiated performance of the communication during uplink transmit switching.

10. The method of claim 9, further comprising:
performing, by the RF front end, closed loop antenna tuning of more than one antenna tuner previously to being configured for the uplink transmit switching; and
in response to UCI scheduling the uplink transmit switching, configuring the tuner controller to discontinue closed loop tuning in preparation for open loop tuning for uplink transmit switching in support of carrier aggregation transmission.

11. The method of claim 9, further comprising:
transmitting, to the serving network device, a subsequent request for subsequent uplink resources to transmit subsequent data packets; and
in response to receiving, from the serving network device, a subsequent UCI that indicates a change in an uplink carrier aggregation configuration from the UCI previously received:
preloading the tuner controller with at least three transmission codes of the plurality of tune codes that correspond to RF bands of subsequent uplink transmit switching modes for uplink carrier aggregation configured by the subsequent UCI;
for each uplink slot, determining, based on the subsequent UCI, an uplink transmit switching mode and an associated tune code preloaded in the tune controller that provides a best radiated performance for RF bands of scheduled resources during the slot; and
activating the associated tune code using a mobile industry processor interface (MIPI) trigger or dedicated hardware trigger to optimize radiated performance of the communication during uplink transmit switching.

12. The method of claim 11, wherein the change in the uplink carrier aggregation configuration is from among a group comprising: (i) a first mode change between FDD uplink SISO and TDD uplink MIMO; (ii) a second mode change between FDD uplink MIMO and TDD uplink SISO; (iii) a third mode change between FDD uplink MIMO and TDD uplink MIMO; and
(iv) a fourth mode change between a first TDD band uplink MIMO and a second TDD band uplink MIMO using different RF bands than the first TDD band uplink MIMO.

13. The method of claim 9, wherein the at least three transmission tune codes comprise: (i) a first uplink carrier tune code; (ii) a second uplink carrier tune code; and (iii) a combined first and second uplink carriers tune code.

14. The method of claim 9, further comprising:
selecting the corresponding transmission tune code based on a truth table that cross references each unique combination of one or more uplink carrier to a corresponding transmission tune code that is optimized for the unique combination.

15. The method of claim 9, wherein the at least three transmission tune codes comprise tune codes optimized for unique combinations of one or more of at least three uplink carriers.

16. The method of claim 9, further comprising:
transmitting, to a serving network device, a subsequent request for subsequent uplink resources to transmit subsequent data packets; and
in response to receiving, from the serving network device, subsequent uplink control information (UCI) scheduling resources:
reconfiguring the communication device to discontinue uplink transmit switching in a carrier aggregation mode;
discontinuing open loop tuning; and
reconfiguring the tuner controller for closed loop antenna tuning.

17. A computer program product comprising:
a computer readable storage device; and
program code on the computer readable storage device that when executed by a processor associated with a communication device, the program code is configured to cause the communication device to provide functionality of:
transmitting, to a serving network device, a request for uplink resources to transmit data packets; and
in response to receiving, a serving network device, uplink control information (UCI) scheduling resources for uplink transmit switching in support of a carrier aggregation mode with consecutive uplink slots scheduled across carriers:
preloading a tuner controller of a radio frequency (RF) front end of the communication device with at least three transmission codes of a plurality of tune codes that correspond to RF bands of the uplink transmit switching modes for uplink carrier aggregation configured by the UCI, respectively using time division duplex (TDD), frequency division duplex (FDD), or both TDD and FDD;
for each uplink slot, determining, based on the UCI, an uplink transmit switching mode and an associated tune code preloaded in the tune controller that provides a best radiated performance for scheduled resources during the slot; and
activating the associated tune code using a mobile industry processor interface (MIPI) trigger or dedicated hardware trigger to optimize radiated performance of the communication during uplink transmit switching.

18. The computer program product of claim 17, wherein the program code is configured to cause the communication device to provide functionality of:
performing, by an RF front end previously to being configured for the uplink transmit switching, closed loop antenna tuning of more than one antenna tuner; and
in response to UCI scheduling the uplink transmit switching, configuring the tuner controller to discontinue closed loop tuning in preparation for open loop tuning for uplink transmit switching in support of carrier aggregation transmission.

19. The computer program product of claim 17, wherein the program code is configured to cause the communication device to provide functionality of:
transmitting, to the serving network device, a subsequent request for subsequent uplink resources to transmit subsequent data packets; and
in response to receiving, from the serving network device, a subsequent UCI that indicates a change in an uplink carrier aggregation configuration from the UCI previously received:
preloading the tuner controller with at least three transmission codes of the plurality of tune codes that correspond to RF bands of subsequent uplink transmit switching modes for uplink carrier aggregation configured by the subsequent UCI;
for each uplink slot, determining, based on the subsequent UCI, an uplink transmit switching mode and an associated tune code preloaded in the tune controller that provides a best radiated performance for RF bands of scheduled resources during the slot; and
activating the associated tune code using a mobile industry processor interface (MIPI) trigger or dedicated hardware trigger to optimize radiated performance of the communication during uplink transmit switching between a combination of one or more of at least two uplink carriers.

20. The computer program product of claim 17, wherein the program code is configured to cause the communication device to provide functionality of:
transmitting, to a serving network device, a subsequent request for subsequent uplink resources to transmit subsequent data packets; and
in response to receiving, from the serving network device, subsequent uplink control information (UCI) scheduling resources:
reconfiguring the communication device to discontinue uplink transmit switching in a carrier aggregation mode;
discontinuing open loop tuning; and
reconfiguring the tuner controller for closed loop antenna tuning.
